(19) United States
(12) Patent Application Publication
(10) Pub. No.: US 2023/0369820 A1
(43) Pub. Date: Nov. 16, 2023

(54) WARP CORRECTION DEVICE

(71) Applicant: YAZAKI CORPORATION, Tokyo (JP)

(72) Inventors: Kazuhiro IZUMO, Makinohara-shi (JP); Shinobu KAYAMA, Makinohara-shi (JP)

(73) Assignee: YAZAKI CORPORATION, Tokyo (JP)

(21) Appl. No.: 18/192,315

(22) Filed: Mar. 29, 2023

(30) Foreign Application Priority Data
May 16, 2022 (JP) 2022-080455

(51) Int. Cl. H01R 43/16

(52) U.S. Cl. CPC H01R 43/16

(57) ABSTRACT

A warp correction device that corrects warp of an elongated plate-shaped terminal in a width direction is provided. The warp correction device includes a mounting table on which the terminal is mounted, a pressing member configured to press the terminal mounted on the mounting table, and a control unit configured to control pressing of the pressing member on the terminal, and the pressing member includes a protrusion that presses a portion of a surface of the terminal on a warping side of the terminal in the width direction.

### CROSS REFERENCE TO RELATED APPLICATIONS

This application is based on and claims priority from Japanese patent application No. 2022-80455 filed on May 16, 2022, the entire contents of which are incorporated herein by reference.

### TECHNICAL FIELD

The present disclosure relates to a warp correction device that corrects warp of a terminal in a width direction.

### BACKGROUND ART

A terminal of a printed circuit board (PCB) connector or the like mounted on a circuit board is manufactured (formed) by, for example, punching a strip-shaped metal plate with a progressive press die. When the terminal is manufactured in this manner, warp or the like may occur in the formed terminal at a stage of sequentially punching the metal plate. This may cause defects in a product (PCB connector in this example). For example, complication of workability of mounting of the PCB connector on the circuit board may be considered due to the defects.

In Patent Literature 1, a terminal is sandwiched between a die and a punch having a specific structure, and plastic working is performed in a direction opposite to a warping direction based on the principle of three-point bending to correct and modify warp of the terminal.

### CITATION LIST

### Patent Literature

Patent Literature 1: Japanese Patent No. 4271832

### SUMMARY OF INVENTION

Here, the warp of the terminal includes warp or deflection of the terminal in a plate thickness direction, and warp or deflection (so-called bending) of the terminal in a width direction. However, in a method according to Patent Literature 1, the warp in the plate thickness direction can be corrected and modified, but the bending cannot be corrected or modified. On the other hand, the bending should also be corrected and modified as the bending may cause defects in a product.

The present disclosure has been made in view of the above-described circumstances, and an object thereof is to provide a warp correction device capable of correcting warp (so-called bending) of a terminal in a width direction.

In order to achieve the above object, a warp correction device according an embodiment is characterized as follows.

The warp correction device that corrects warp of an elongated plate-shaped terminal in a width direction includes:
a mounting table on which the terminal is mounted;
a pressing member configured to press the terminal mounted on the mounting table; and
a control unit configured to control pressing of the pressing member on the terminal, and
the pressing member includes a protrusion that presses a portion of a surface of the terminal on a warping side of the terminal in the width direction.

### BRIEF DESCRIPTION OF DRAWINGS

FIG. 1 is a schematic top view showing bending of chain terminals formed by punching a strip-shaped metal plate with a progressive press die.

FIG. 2 is a schematic front view showing a state in which a terminal is mounted on a die of a warp correction device.

FIG. 3 is a schematic front view showing a state in which the terminal mounted on the die is pressed by a punch of the warp correction device.

FIG. 4 is a schematic top view showing the terminals whose bending is corrected by the warp correction device.

FIG. 5 is an enlarged view of a part A in FIG. 4.

FIG. 6 is an enlarged perspective view of a recess formed in the terminal.

FIG. 7 is a view corresponding to FIG. 5, showing an example of a bending correction method (angle adjustment) when an amount of bending is large.

FIG. 8 is a view corresponding to FIG. 6, showing an example of a bending correction method (depth adjustment) when an amount of bending is large.

### DESCRIPTION OF EMBODIMENTS

### Embodiment

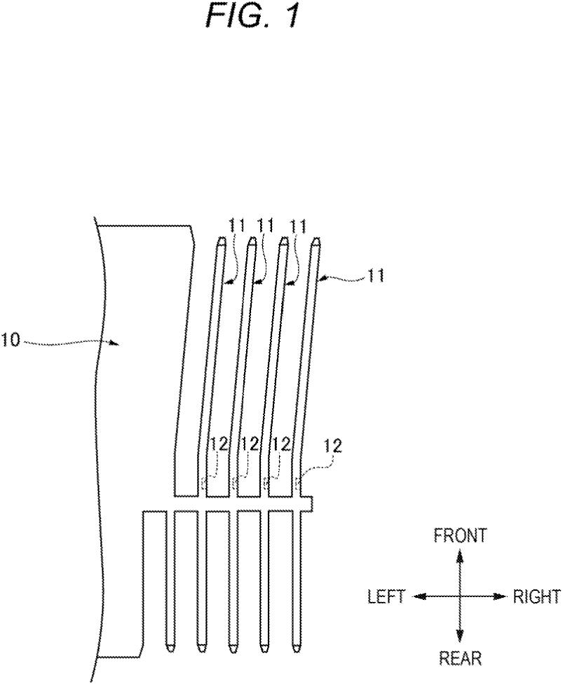

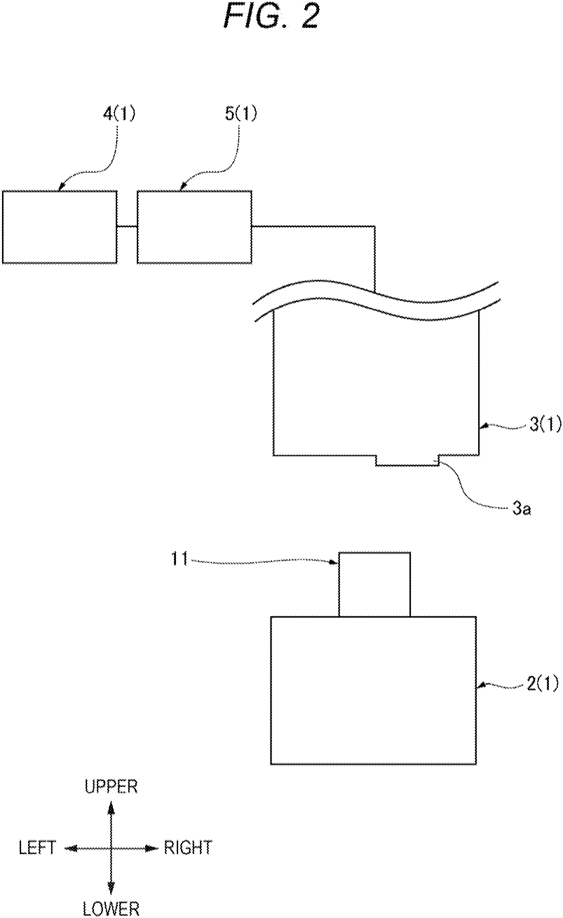

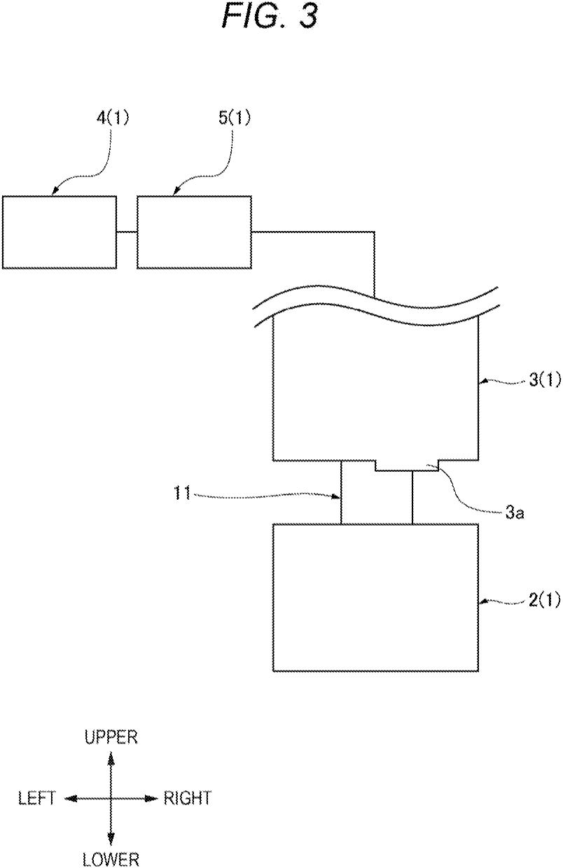

Hereinafter, a warp correction device 1 according to an embodiment of the present invention shown in FIGS. 2 to 3 will be described with reference to the drawings. An object of the warp correction device 1 is to correct warp and deflection (hereinafter, also referred to as “bending”) of a terminal 11 in a width direction shown in FIG. 1. The terminal 11 is manufactured (formed) by punching a strip-shaped metal plate 10 with a progressive press die, and is used as a terminal of a PCB connector (not shown), for example. A group of these terminals 11 is so-called chain terminals. Then, the terminal 11 is conveyed to the warp correction device 1 in the next stage of a punching process by the progressive press die, and the bending is corrected by the warp correction device 1.

Hereinafter, as shown in FIGS. 1 to 8, “front”, “rear”, “left”, “right”, “upper”, and “lower” are defined for convenience of description. A “front-rear direction”, a “left-right direction”, and an “upper-lower direction” are orthogonal to one another. The front-rear direction corresponds to a longitudinal direction of the terminal 11. The left-right direction corresponds to a “width direction” of the terminal 11 according to the present invention. The upper-lower direction corresponds to an up-down movement direction of a punch 3. A right side in the left-right direction corresponds to a “warping side” according to the present invention, and a left side in the left-right direction corresponds to a “side opposite to the warping side” according to the present invention. The “warping side” according to the present invention is also referred to as a bending side.

First, a configuration example of the warp correction device 1 will be described. As shown in FIGS. 2 and 3, the warp correction device 1 includes a die 2 on which the elongated plate-shaped terminal 11 is mounted, the punch 3 that presses the terminal 11 mounted on the die 2, and a control unit 4 that controls pressing of the punch 3 on the terminal 11. The die 2 corresponds to a “mounting table” according to the present invention, and the punch 3 corresponds to a “pressing member” according to the present invention.

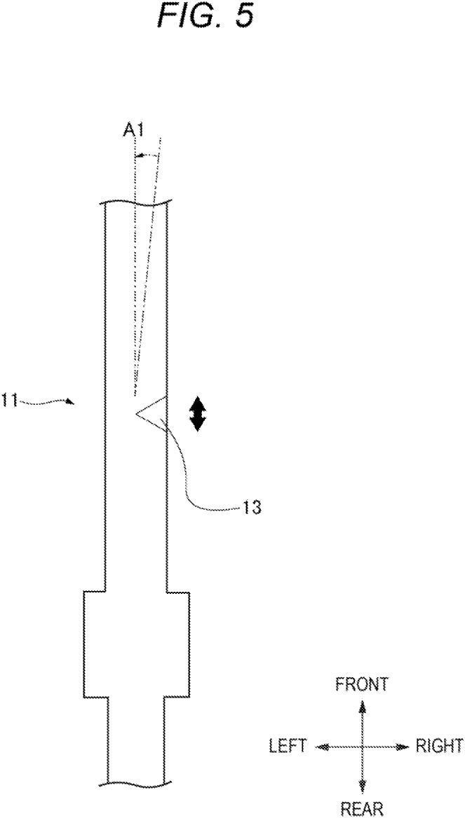

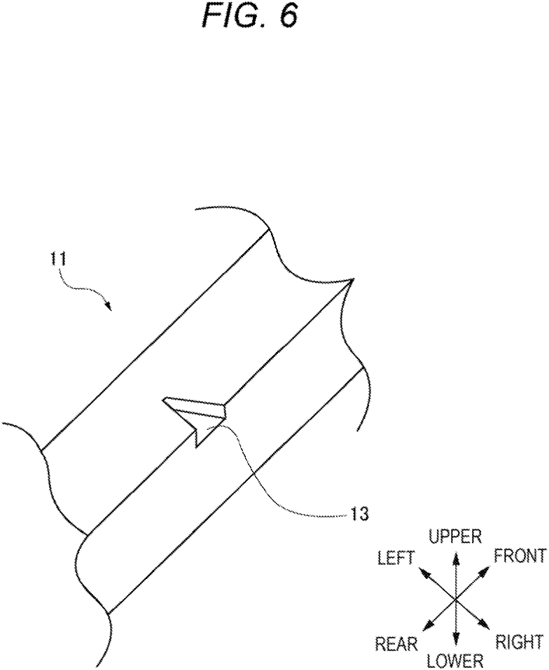

The punch 3 is connected to a known drive source 5 such as a motor, and is displaceable (that is, move up and down) so as to approach or move away from the die 2. The punch 3 has a wedge-shaped protrusion 3a (see a recess 13 of the terminal 11 in FIGS. 5 and 6) that presses a portion of an upper surface of the terminal 11 on the bending side in the width direction (hereinafter, also referred to as a “pressing position 12”). That is, the punch 3 operates in the same manner as a known punch, in which the punch 3 moves down when the protrusion 3a presses the terminal 11, and moves up when the pressing on the terminal 11 is completed.

As the pressing position 12, it is preferable to select, for example, a position located within a housing (not shown) in which the terminal 11 is held and accommodated. Any portion may be selected as the pressing position 12 as long as the terminal 11 and a product (PCB connector in this example) are not affected in function, and, for example, a position located outside the housing (that is, exposed to the outside) may be selected. The best position is appropriately selected as the pressing position 12.

The control unit 4 is connected to the drive source 5 to control up-down movement of the punch 3. By equipping the control unit 4 with an AI function, the control unit 4 can automatically control the pressing of the punch 3 on the terminal 11 according to a measured amount of bending of the terminal 11.

Next, the amount of bending the terminal 11 will be described. The amount of bending corresponds to an “amount of warp” according to the present invention, and represents a magnitude of the bending of the terminal 11. Since the amount of bending affects material characteristics of the terminal 11 (that is, the metal plate 10) and dimensions of the length, width, and the like of the terminal 11, the amount of bending of each terminal 11 is approximately equal for each manufacturing lot. Therefore, an amount of correction is adjusted for each manufacturing lot from a viewpoint of productivity and the like. The amount of correction may be adjusted for each terminal 11 in each manufacturing lot.

Next, a method of measuring the amount of bending will be described. As the method of measuring the amount of bending, the amount of bending may be calculated in advance based on the material characteristics of the terminal 11 and the dimensions of the terminal 11, or may be detected by a camera provided in the progressive press die, the warp correction device 1, or the like. The amount of bending measured in this manner is input to the control unit 4. That is, the control unit 4 controls the pressing of the punch 3 on the terminal 11 according to the input (measured) amount of bending. The amount of bending may be measured by the control unit 4.

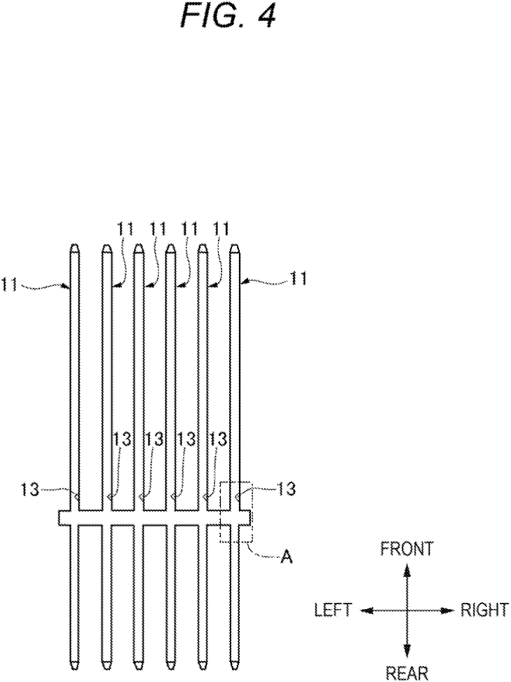

Next, the terminal 11 corrected by the warp correction device 1 will be described. As shown in FIGS. 4 to 6, a wedge-shaped (substantially triangular prism-shaped) recess 13 corresponding to a shape of the protrusion 3a is formed in the terminal 11 pressed by the protrusion 3a of the punch 3. Accordingly, the terminal 11 extends with the recess 13 as a base point (see an arrow in FIG. 5), and is deformed so as to warp toward a side opposite to the bending side. As a result, the terminal 11 extends substantially straight in the front-rear direction with the bending being canceled. That is, the bending of the terminal 11 is corrected due to formation of the recess 13.

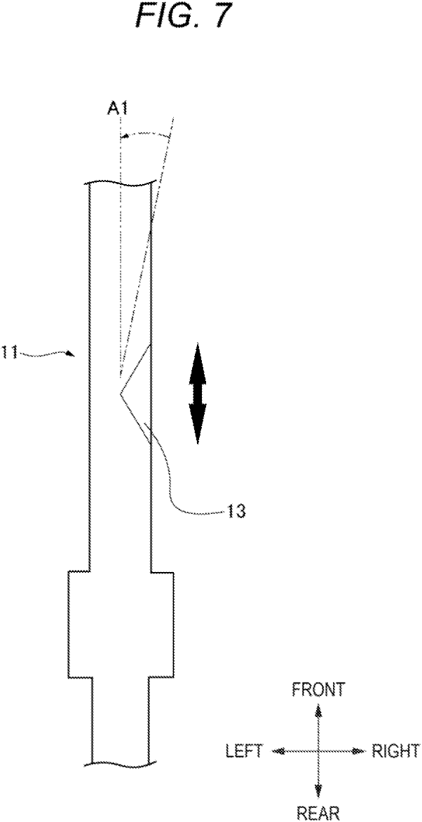

By the way, the amount of correction of the terminal 11 varies depending on the amount of bending. Therefore, the amount of correction is adjusted according to the amount of bending. For example, an amount of deformation of the terminal 11 can be adjusted by adjusting an angle of a tip end portion of the protrusion 3a (specifically, a corner portion closest to a central axis A1 of the terminal 11) (see FIGS. 5 and 7). Specifically, when the amount of bending is large, the amount of deformation of the terminal 11 can be increased by increasing the angle. On the other hand, when the amount of bending is small, the angle may be reduced. That is, the amount of correction can be adjusted by preparing a plurality of types of punches 3 including the protrusions 3a having different angles, and changing the punch 3 to be used according to the amount of bending.

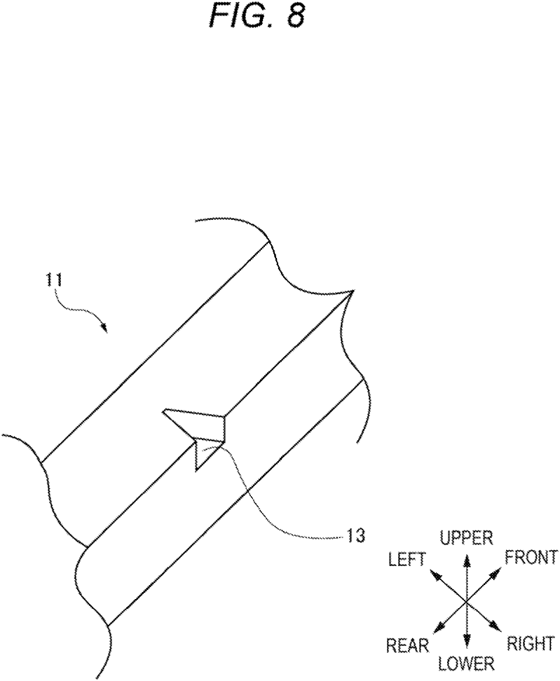

The amount of deformation of the terminal 11 can be adjusted by adjusting a depth of the recess 13 of the terminal 11 (see FIGS. 6 and 8). Specifically, when the amount of bending is large, the amount of deformation of the terminal 11 can be increased by forming the recess 13 deep. On the other hand, when the amount of bending is small, the recess 13 may be formed shallow. That is, the amount of correction can be adjusted by preparing a plurality of types of punches 3 including the protrusions 3a having different heights, changing the punch 3 to be used according to the amount of bending, or changing a pressing force of the punch 3 on the terminal 11.

The amount of correction can be adjusted by changing the pressing position 12 along the front-rear direction. Specifically, when the amount of bending is large, the pressing position 12 may be set in the vicinity of a base end (rear end) of a bending portion, and when the amount of bending is small, the pressing position 12 may be set to a tip end (front end) of the bending portion. In this way, adjustment of the amount of correction according to the amount of bending is not limited to the above, and the best method is appropriately selected.

### Operational Effects

According to the warp correction device 1 according to the present embodiment, the terminal 11 is pressed by the punch 3 to form the recess 13 having a shape corresponding to that of the protrusion 3a. Accordingly, the terminal 11 extends in the front-rear direction with the recess 13 as the base point, and is deformed so as to warp toward the side opposite to the bending side. As a result, the terminal 11 extends substantially straight in the front-rear direction with the bending being canceled. That is, the bending of the terminal 11 is corrected.

Further, according to the warp correction device 1 according to the present embodiment, since the protrusion 3a of the punch 3 has the wedge shape, the recess 13 formed in the terminal 11 has the wedge shape. Accordingly, the terminal 11 can easily extend in the front-rear direction with the recess 13 as the base point.

In this way, the warp correction device 1 according to the present embodiment can correct the warp (so-called bending) of the terminal in the width direction.

Further, according to the warp correction device 1 according to the present embodiment, the bending can be corrected more appropriately by controlling the pressing of the punch 3 on the terminal 11 according to the measured amount of bending.

By correcting the bending of the terminal 11, an influence on a manufacturing process of the product (PCB connector in this example) after the terminal 11 is manufactured can be reduced, and a quality of the product can be improved.

### Other Embodiments

The present disclosure is not limited to the above-described embodiment, and modifications, improvements, and the like can be made as appropriate. In addition, the material, shape, size, number, arrangement position, or the like of each component in the above-described embodiment are optional and are not limited as long as the present disclosure can be achieved.

In the above-described embodiment, a punch is used as the “pressing member”, but a die may be used as the “pressing member”. In this way, the “pressing member” is not particularly limited.

An example in which the upper surface of the terminal 11 is used as a surface of the terminal 11 has been described in the above-described embodiment, but a lower surface of the terminal 11 may be used as the surface of the terminal 11. That is, a portion of the lower surface of the terminal 11 on the bending side in the width direction may be pressed by the pressing member (punch 3).

According to an embodiment, a warp correction device (1) that corrects warp of an elongated plate-shaped terminal (11) in a width direction includes,
a mounting table (2) on which the terminal (11) is mounted,
a pressing member (3) configured to press the terminal (11) mounted on the mounting table (2), and
a control unit (4) configured to control pressing of the pressing member (3) on the terminal (11), and
the pressing member (3) includes a protrusion (3a) that presses a portion of a surface of the terminal on a warping side of the terminal in the width direction.

In the warp correction device (1), the terminal (11) may be formed by punching a metal plate (10).

According to the warp correction device configured as above, the terminal mounted on the mounting table is pressed by the protrusion of the pressing member at the portion of the surface of the terminal on the warping side in the width direction. In other words, a recess having a shape corresponding to that of the protrusion of the pressing member is formed in the portion of the surface of the terminal on the warping side in the width direction. Accordingly, the terminal extends in a longitudinal direction with the recess as a base point, and is deformed so as to warp toward a side opposite to the warping side. As a result, the terminal extends substantially straight in the longitudinal direction with the warp (so-called bending) in the width direction cancelled. That is, the bending of the terminal is corrected. In this way, the warp correction device having the present configuration can correct the warp of the terminal in the width direction.

In the warp correction device (1), the protrusion (3a) may have a wedge shape.

According to the warp correction device configured as above, since the protrusion of the pressing member has the wedge shape, the recess formed in the terminal has the wedge shape. Accordingly, the terminal can easily extend in the longitudinal direction with the recess as the base point.

In the warp correction device (1), the control unit (4) may control the pressing of the pressing member (3) on the terminal (11) according to a measured amount of warp.

According to the warp correction device configured as above, the bending can be corrected more appropriately by controlling the pressing of the pressing member on the terminal according to the measured amount of warp (so-called amount of bending).

A warp correction device according to an embodiment will be described below.

According to the warp correction device having the present configuration, the terminal mounted on the mounting table is pressed by the protrusion of the pressing member at the portion of the surface of the terminal on the warping side in the width direction. In other words, a recess having a shape corresponding to that of the protrusion of the pressing member is formed in the portion of the surface of the terminal on the warping side in the width direction. Accordingly, the terminal extends in a longitudinal direction with the recess as a base point, and is deformed so as to warp toward a side opposite to the warping side. As a result, the terminal extends substantially straight in the longitudinal direction with the warp or deflection (so-called bending) in the width direction canceled. That is, the bending of the terminal is corrected. In this way, the warp correction device having the present configuration can correct the bending of the terminal.

What is claimed is:

1. A warp correction device that corrects warp of an elongated plate-shaped terminal in a width direction, the warp correction device comprising:
a mounting table on which the terminal is mounted;
a pressing member configured to press the terminal mounted on the mounting table; and
a control unit configured to control pressing of the pressing member on the terminal, wherein
the pressing member includes a protrusion that presses a portion of a surface of the terminal on a warping side of the terminal in the width direction.

2. The warp correction device according to claim 1, wherein the terminal is formed by punching a metal plate.

3. The warp correction device according to claim 1, wherein the protrusion has a wedge shape.

4. The warp correction device according to claim 1, wherein
the control unit controls the pressing of the pressing member on the terminal according to a measured amount of warp.
